(19) United States
(12) Patent Application Publication
(10) Pub. No.: US 2021/0249679 A1
(43) Pub. Date: Aug. 12, 2021

(54) STACK ACTIVE AREA LOAD SENSING

(71) Applicant: GM GLOBAL TECHNOLOGY OPERATIONS LLC, Detroit, MI (US)

(72) Inventor: Jeffrey A. Rock, Rochester Hills, MI (US)

(73) Assignee: GM GLOBAL TECHNOLOGY OPERATIONS LLC, Detroit, MI (US)

(21) Appl. No.: 16/785,131

(22) Filed: Feb. 7, 2020

(51) Int. Cl. H01M 8/2404; H01M 8/04089; H01M 8/22

(52) U.S. Cl. CPC H01M 8/2404; H01M 2250/20; H01M 8/225; H01M 8/04104

(57) ABSTRACT

A fuel cell system includes a dry end unit, a wet end unit and a plurality of fuel cells. The dry end unit has a dry base plate and a dry intermediate plate. The dry intermediate plate is initially moveable relative to the dry base plate during a fabrication of the fuel cell system. The wet end unit has a wet base plate and a wet intermediate plate. The wet intermediate plate adjoins the wet base plate. The plurality of fuel cells is disposed between the dry intermediate plate and the wet intermediate plate. Each of the plurality of fuel cells includes a perimeter area that surrounds an active area. The dry intermediate plate is fixed in position relative to the dry base plate during the fabrication to maintain the active areas of the plurality of fuel cells at a target active area pressure.

### INTRODUCTION

The present disclosure relates to a system and a method of fabrication for stack active area load sensing.

Existing stack build processes compress a stack of fuel cells once with a simulated end unit in a split compression jig in order to measure a load applied on fuel cell active areas for quality control purposes. After the measurement is made, the stack is decompressed, an actual end unit is installed, and the stack is compressed a second time. The second compression introduces tolerance effects of the end unit, increases cycle times, and provides an opportunity for fuel cell seals to fall into incorrect alignment states. The initial compression using the simulated end unit results in a profile that will not account for the effects of gap closures, hardware deflections, and dimensional differences between the simulated end unit and the actual end unit. What is desired is a technique for fuel cell stack active area load sensing to provide for a single compression cycle fabrication of the fuel cell stack.

### SUMMARY

A fuel cell system is provided herein. The fuel cell system comprises a dry end unit, a wet end unit and a plurality of fuel cells. The dry end unit has a dry base plate and a dry intermediate plate. The dry intermediate plate is initially moveable relative to the dry base plate during a fabrication of the fuel cell system. The wet end unit has a wet base plate and a wet intermediate plate. The wet intermediate plate adjoins the wet base plate. The plurality of fuel cells is disposed between the dry intermediate plate and the wet intermediate plate. Each of the plurality of fuel cells includes a perimeter area that surrounds an active area. The dry intermediate plate is fixed in position relative to the dry base plate during the fabrication to maintain the active areas of the plurality of fuel cells at a target active area pressure.

In one or more embodiments of the fuel cell system, the dry intermediate plate comprises: a terminal plate configured to engage the plurality of fuel cells; an insulator plate that has a plurality of holes through which a pin array applies a load to the terminal plate to compress the plurality of fuel cells; and a gap between the terminal and the insulator plate to aid in measuring the load through at least one pin of the pin array.

In one or more embodiments, the fuel cell system further comprises a first electrical terminal electrically connected to the terminal plate, extending through the dry base plate, and adjustable in a direction perpendicular to the dry intermediate plate.

In one or more embodiments, the fuel cell system further comprises a plurality of straps configured to secure the dry end unit mechanically to the wet end unit.

In one or more embodiments of the fuel cell system, the pin array is removed from the fuel cell system after the dry end unit is secured to the wet end unit.

In one or more embodiments of the fuel cell system, the pin array comprises a plurality of active area pins and a plurality of perimeter area pins, the active area pins compress the active areas of the plurality of fuel cells to the target active area pressure, and the plurality of perimeter pins compress the perimeter areas of the plurality of fuel cells to a target perimeter area pressure.

In one or more embodiments of the fuel cell system, the target active area pressure is different than the target perimeter area pressure.

In one or more embodiments of the fuel cell system, the dry intermediate plate is fixed in position relative to the dry base plate by a plurality of jack screws disposed between the dry intermediate plate and the dry base plate or a plurality of shims disposed between the dry intermediate plate and the dry base plate.

In one or more embodiments of the fuel cell system, the fuel cell system forms part of a vehicle.

A method for fabricating a fuel cell system is provided herein. The method comprises placing a wet end unit into a compression machine, wherein the wet end unit includes a wet base plate and a wet intermediate plate, and the compression machine includes a pin array; placing a plurality of fuel cells into the compression machine adjoining the wet end unit, wherein each of the plurality of fuel cells includes a perimeter area that surrounds an active area; placing a dry end unit into the compression machine adjoining the plurality of fuel cells, wherein the dry end unit includes a dry base plate and a dry intermediate plate, and the dry intermediate plate is moveable relative to the dry base plate; applying a load to the dry intermediate plate with the pin array of the compression machine to compress the plurality of fuel cells between the dry intermediate plate and the wet intermediate plate, wherein the load is increased until the active areas of the plurality of fuel cells are compressed to a target active area pressure; and fixing the dry intermediate plate in position relative to the dry base plate to maintain the active areas of the plurality of fuel cells at the target active area pressure.

In one or more embodiments, the method further comprises securing the dry end unit mechanically to the wet end unit.

In one or more embodiments, the method further comprises removing the pin array from the fuel cell system after the dry end unit is secured to the wet end unit.

In one or more embodiments of the method, the pin array comprises a plurality of active area pins and a plurality of perimeter area pins, the active area pins compress the active areas of the plurality of fuel cells to the target active area pressure, and the plurality of perimeter pins compress the perimeter areas of the plurality of fuel cells to a target perimeter area pressure.

In one or more embodiments of the method, the target active area pressure is different than the target perimeter area pressure.

In one or more embodiments, the method further comprises measuring an active area pressure asserted by the plurality of active area pins; and measuring a perimeter area pressure asserted by the plurality of perimeter area pins.

In one or more embodiments, the method further comprises stopping movement of the active area pins in response to the active area pressure as measured reaching the target active area pressure; and stopping movement of the perimeter area pins in response to the perimeter area pressure as measured reaching the target perimeter area pressure.

A vehicle is provided herein. The vehicle comprises an electric motor configured to provide propulsion to the vehicle; a plurality of fuel tanks configured to store fuel; and a fuel cell system configured to convert the fuel into electricity that powers the electric motor. The fuel cell system comprises a dry end unit, a wet end unit and a plurality of fuel cells. The dry end unit has a dry base plate and a dry intermediate plate. The dry intermediate plate is initially moveable relative to the dry base plate during a fabrication of the fuel cell system. The wet end unit has a wet base plate and a wet intermediate plate. The wet intermediate plate adjoins the wet base plate. The plurality of fuel cells is disposed between the dry intermediate plate and the wet intermediate plate. Each of the plurality of fuel cells includes a perimeter area that surrounds an active area. The dry intermediate plate is fixed in position relative to the dry base plate during the fabrication to maintain the active areas of the plurality of fuel cells at a target active area pressure.

In one or more embodiments of the vehicle, a pin array used to compress the dry end plate toward the wet end plate comprises a plurality of active area pins and a plurality of perimeter area pins, the active area pins compress the active areas of the plurality of fuel cells to the target active area pressure, and the plurality of perimeter pins compress the perimeter areas of the plurality of fuel cells to a target perimeter area pressure.

In one or more embodiments of the vehicle, the target active area pressure is different than the target perimeter area pressure.

In one or more embodiments of the vehicle, the plurality of fuels comprises hydrogen and oxygen.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic diagram illustrating a context of a vehicle in accordance with one or more exemplary embodiments.

FIG. 2 is a schematic partially exposed perspective diagram of an example implementation of a fuel cell system accordance with one or more exemplary embodiments of the vehicle.

FIG. 3 is a schematic plan diagram of a fuel cell in accordance with one or more exemplary embodiments of the fuel cell system.

FIG. 4 is a schematic diagram of a compression machine in accordance with one or more exemplary embodiments.

FIG. 5 is a schematic partially exploded perspective diagram of a portion of the fuel cell system in accordance with one or more exemplary embodiments of the fuel cell system.

FIG. 6 is a schematic cross-sectional perspective diagram of a portion of the dry end unit in accordance with one or more exemplary embodiments of the fuel cell system.

FIG. 7 is a schematic cross-sectional perspective diagram of a region of a dry end unit in accordance with one or more exemplary embodiments of the fuel cell system.

FIG. 8 is a schematic cross-sectional perspective diagram of an alternative portion of the dry end unit in accordance with one or more exemplary embodiments of the fuel cell system.

FIG. 9 is a schematic diagram of a method of fabricating the fuel cell system in accordance with one or more exemplary embodiments.

FIG. 10 is a graph of loading profiles and unloading profiles of the fuel cells in accordance with one or more example embodiments of the fuel cell system.

### DETAILED DESCRIPTION

Embodiments of the disclosure generally provide a design and/or a process for monitoring a load on an active area of a stack of fuel cells during a single compression cycle process. A compression machine may use a loading profile and a pin array having one or more independently moveable pins or sets of pins. A portion of the pin array may compress the active areas of the fuel cells. An active area pressure applied to the active areas may be measured to control the active area compression. A remainder of the pin array may compress a perimeter area of the fuel cells. In various embodiments, a perimeter area pressure applied to the perimeter areas may be measured to control the perimeter area compression. The design may include two “center” post-style electrical terminals. At least one of the electrical terminals may be moved independently of and perpendicular to an intermediate plate of a corresponding end unit to account for different final thicknesses of the compressed fuel cell stack. In various embodiments, the movement may enable measurements. In some designs the electrical terminals may have fixed heights relative to the end units.

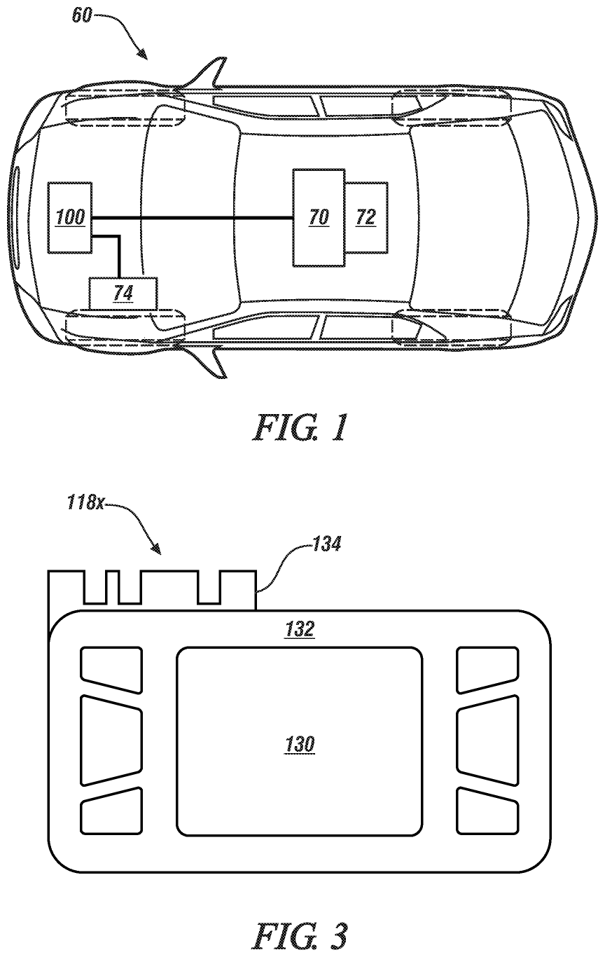

Referring to FIG. 1, a schematic diagram illustrating a context of a vehicle 60 is shown in accordance with one or more exemplary embodiments. The vehicle 60 generally comprises a first fuel tank 70, a second fuel tank 72, an electric motor 74 and a fuel cell system 100. In various embodiments, the vehicle 60 may include power converters, electronic control units, batteries, valves, compressors, tubing, temperature regulators and associated ancillary devices related to operation of the fuel cell system 100. An electrical power produced by the fuel cell system 100 may be supplied to electric motor 74 for propulsion of the vehicle 60 and/or stored inside the vehicle 60 for later use.

The vehicle 60 may include, but is not limited to, mobile objects such as automobiles, trucks, motorcycles, boats, trains and/or aircraft. In some embodiments, the vehicle 60 may include stationary objects such as billboards, kiosks, power back-up systems (e.g., uninterruptible power supplies) and/or marquees. Other types of vehicles 60 may be implemented to meet the design criteria of a particular application.

Individual ones of the fuel tanks 70-72 may be implemented as a hydrogen fuel tank configured to store compressed hydrogen and an oxygen tank configured to store compressed oxygen. In various embodiments, the fuel tanks 70 and 72 may by Type IV tanks capable of storing the gasses at pressures of up to approximately 700 bars. Other types of portable tanks, other tank technologies and/or other capacities may be implemented to meet the design criteria of a particular application.

The electric motor 74 is generally operational to provide torque and rotational motion to one or more wheels of the vehicle 60. In various embodiments, the electric motor 74 may be implemented as a permanent magnet electrical motor. Other types of electric motors, such as induction motors, may be implemented to meet the design criteria of a particular application.

The fuel cell system 100 may be implemented as one or more fuel cell stacks. The fuel cell system 100 is generally operational to generate electrical power from the fuel received from the fuel tanks 70 and 72. The electrical power may be generated in a range of approximately 300 Vdc to approximately 1000 Vdc. The electrical power conveyed may range from approximately 70 kilowatts to approximately 100 kilowatts. Other ranges of electrical power may be implemented to meet the design criteria of a particular application.

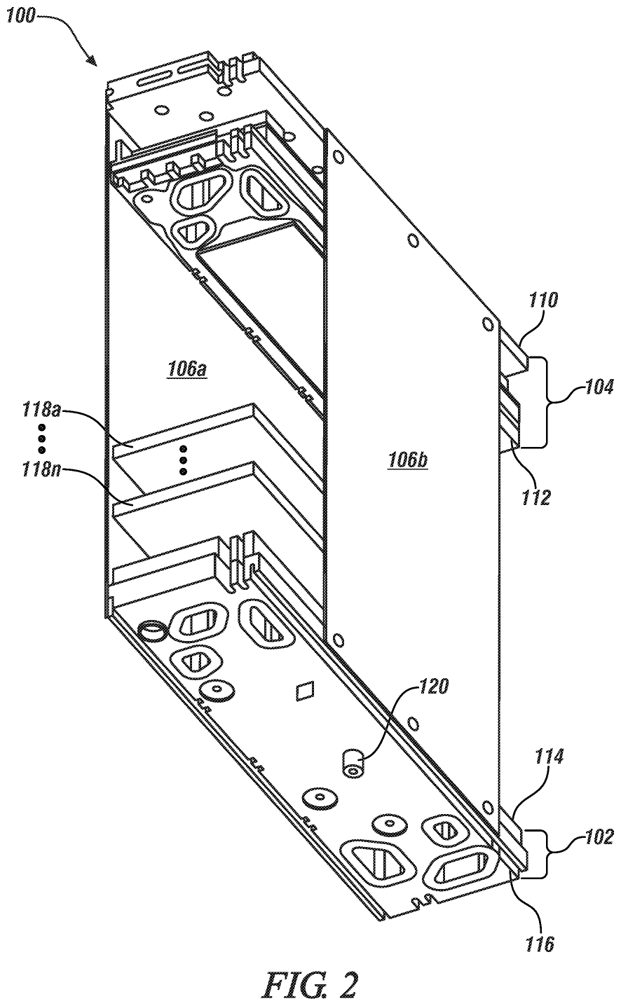

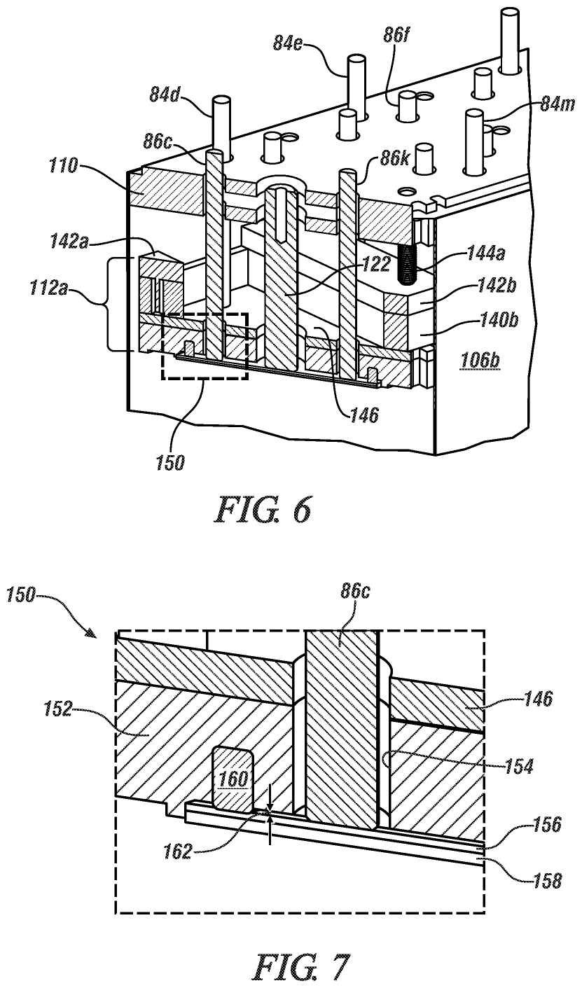

Referring to FIG. 2, a schematic partially exposed perspective diagram of an example implementation of the fuel cell system 100 is shown in accordance with one or more exemplary embodiments of the vehicle 60. The fuel cell system 100 generally comprises, a wet end unit (or assembly) 102, a dry end unit (or assembly) 104, multiple sidewalls 106a-106d (only sidewalls 106a and 106b are shown for clarity), multiple fuel cells 118a-118n arranged in a stack, a first electrical terminal 122 (see FIG. 6) and a second electrical terminal 120. The dry end unit 104 generally comprises a dry base plate (or assembly) 110 and a dry intermediate plate (or assembly) 112. The wet end unit 102 generally comprises a wet intermediate plate (or assembly) 114 and a wet base plate (or assembly) 116.

The wet end unit 102 may be configured to receive fluids and exhaust byproducts of the fuel cells 118a-118n from the fuel cell system 100. The wet base plate 116 may define a first outer end (or side) of the fuel cell system 100. The wet intermediate plate 114 and the second electrical terminal 120 may be mounted on the wet base plate 116. The second electrical terminal 120 may be in electrical contact with the fuel cells 118a-118n. The second electrical terminal 120 may be mounted on the wet intermediate plate 114. Parts of the wet intermediate plate 114 may implement an insulator plate (or assembly).

The dry end unit 104 may be positioned at an end of the fuel cell system 100. The dry base plate 110 may define a second outer end (or side) of the fuel cell system 100. The second outer end of the fuel cell system 100 may be opposite the first outer end established by the wet base plate 116.

The dry intermediate plate 112 is generally configured to be displaced a variable distance relative to the dry base plate 110. The displacement may be used to compress the fuel cells 118a-118n to a target active area pressure and/or a target perimeter area pressure. In various embodiments, after the fuel cells 118a-118n have been compressed to an appropriate pressure, the displacement of the dry intermediate plate 112 relative to the dry base plate 110 may be fixed to maintain either the target active area pressure or the target perimeter area pressure on the fuel cells 118a-118n while allowing the other variable to be measured to assure compliance within quality limits. In other embodiments, a balance compromise between the two variables may be implemented. In still other embodiments, the two variables may be controlled separately. The first electrical terminal 122 may be in electrical contact with the fuel cells 118a-118n. The first electrical terminal 122 may be mounted on the dry intermediate plate 112 (as shown in FIG. 6). In particular, the first electrical terminal 122 may be mounted on the terminal plate 158 (as shown in FIG. 7). Parts of the dry intermediate plate 112 may implement an insulator plate (or assembly). In some embodiments, some to all of the features of the wet end unit 102 and the dry end unit 104 may be swapped.

The sidewalls 106a-106d may implement additional (e.g., four) outer sides of the fuel cell system 100. The sidewalls 106a-106d are generally operational to provide mechanical support and an environmental seal around the fuel cells 118a-118n. In various embodiments, the sidewalls 106a-106d may be attached to the dry base plate 110 and the wet base plate 116. Attachment may be implemented with bolts. Other attachment techniques may be implemented to meet the design criteria of a particular application.

The fuel cells 118a-118n may be implemented as metal hydride, alkaline, electro-galvanic, or other types of fuel cells. The fuel cells 118a-118n are generally operational to convert the fuels received from the fuel tanks 70 and 72 into electrical power. The electrical power may be routed through the first electrical terminal 122 and the second electrical terminal 120 to the electric motor 74. In various embodiments, a number of the fuel cells 118a-118n within the stack may range from 50 to 500 (e.g., 365) fuel cells.

The second electrical terminal 120 may positioned approximately at a center of the wet end unit 102. The second electrical terminal 120 may protrude a fixed distance from and in a direction perpendicular to the wet end unit 102. Other positions and/or distances may be implemented to meet the design criteria of a particular application.

Referring to FIG. 3, a schematic plain diagram of an example implementation of a fuel cell 118x is shown in accordance with one or more exemplary embodiments of the fuel cell system 100. The fuel cell 118x generally comprises an active area 130, a perimeter area 132 and an edge connector 134. The fuel cell 118x may be representative of each of the fuel cells 118a-118n.

The active area 130 may implement an exchange membrane that defines a cathode side and an anode side. A hydrogen or a hydrogen-rich gas (e.g., a first fuel from the first fuel tank 70) may be supplied as a reactant through a flow path to the anode side of a active area 130 while oxygen (e.g., a second fuel from the second fuel tank 72) may be supplied as a reactant through a separate flow path to the cathode side of the active area 130. Catalysts placed at the anode and cathode generally facilitate an electrochemical conversion of the reactants into electrons and positively charged ions and negatively charged ions that generate the electrical power.

The perimeter area 132 may implement a sealing area. The perimeter area 132 is generally operational to confine a portion of the reactants to the active area 130 and pass another portion of the reactants to other fuel cells 118a-118n in the stack.

The edge connector 134 may implement an electrical connector. The edge connector 134 generally provides an electrical interface to enable a cell voltage monitor circuit to monitor a performance of the fuel cell 118x.

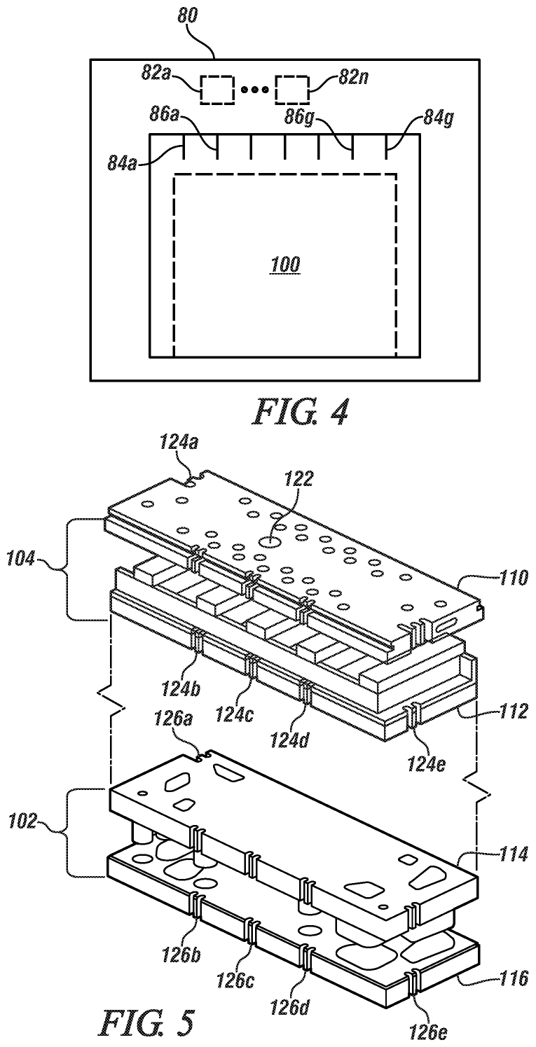

Referring to FIG. 4, a schematic diagram of an example implementation of a compression machine 80 is shown in accordance with one or more exemplary embodiments. The compression (or manufacture) machine 80 generally comprises one or more pressure sensors 82a-82n and a pin array. The pin array generally includes multiple perimeter area pins 84a-84n (only perimeter area pins 84a-84g are shown for clarity) and multiple active area pins 86a-86n (only active area pins 86a-86g are shown for clarity).

The pressure sensors 82a-82n are generally operational to measure a pressure applied by one or more corresponding pins of the active area pins 86a-86n and, optionally, the perimeter area pins 84a-84n. The measured pressure of the pin array (e.g., at least one of the active area pins 86a-86n) may be used to control a load applied to the active areas 130 of the fuel cells 118a-118n as the compression machine 80 pushes the dry intermediate plate 112 (e.g., pushes on the first electrical terminal 122) toward the wet intermediate plate 114. In various embodiments, the measured pressure may include at least one of the perimeter area pins 84a-84n to control another load applied to the perimeter areas 132 of the fuel cells 118a-118n.

The perimeter area pins 84a-84n may be positioned to bear solely on the perimeter areas 132 of the fuel cells 118a-118n. In various embodiments, one or more of the perimeter area pins 84a-84n may be coupled to one or more of the pressure sensors 82a-82n to measure the load being applied to the perimeter areas 132. The measured pressure may be referred to as a perimeter area pressure.

The active area pins 86a-86n may be positioned to bear solely on the active areas 130 of the fuel cells 118a-118n. In various embodiments, one or more of the active area pins 86a-86n may be coupled to one or more of the pressure sensors 82a-82n to measure the load being applied to the active areas 130. The measured pressure may be referred to as an active area pressure.

In some embodiments, the active area pins 86a-86n and the perimeter area pins 84a-84n may be advanced (or moved) together to apply a uniform pressure across the fuel cells 118a-118n. In other embodiments, the active area pins 86a-86n may be advanced independently of the perimeter area pins 84a-84n. Movement of the active area pins 86a-86n may be stopped in response to the active area pressure applied to the active areas 130 reaching a target active area pressure. Movement of the perimeter area pins 84a-84n may be stopped in response to the perimeter area pressure applied to the perimeter areas 132 reaching a target perimeter area pressure.

Referring to FIG. 5, a schematic partially exploded perspective diagram of the example implementation of a portion of the fuel cell system 100 is shown in accordance with one or more exemplary embodiments of the fuel cell system 100. The dry end unit 104 may include multiple dry guide slots 124a-124e and the first electrical terminal 122. The dry guide slots 124a-124e may be used to hold the dry end unit 104 in an appropriate position and orientation while in the compression machine 80.

The wet end unit 102 may include multiple wet guide slots 126a-126e and the second electrical terminal 120 (see FIG. 2). The wet guide slots 126a-126e may be used to hold the wet end unit 102 in an appropriate position and orientation while in the compression machine 80.

Referring to FIG. 6, a schematic cross-sectional perspective diagram of the example implementation of a portion of the dry end unit 104 is shown in accordance with one or more exemplary embodiments of the fuel cell system 100. The dry end unit 104 generally comprises the dry base plate 110, a dry intermediate plate 112a and the first electrical terminal 122. The active area pins 86a-86n (only some active area pins are shown) and the perimeter area pins 84a-84n (only some perimeter area pins are shown) are illustrated in positions to bias the dry intermediate plate 112a toward the wet intermediate plate 114 (e.g., downward as shown in the figure). A region 150 highlights an area of the dry end unit 104 shown in more detail in FIG. 7.

The dry intermediate plate 112a may be a variation of the dry intermediate plate 112. The dry intermediate plate 112a generally comprises multiple cross supports 140a-140n (only cross support 140b is shown), multiple screw plates 142a-142n (only screw plates 142a and 142b are shown), multiple jack screws 144a-144n (only jack screw 144a is shown) and a compression plate 146.

The cross supports 140a-140n may be configured to provide mechanical support to maintain the active area pressure on the active areas 130 of the fuel cells 118a-118n after the fuel cell system 100 has been manufactured. The screw plates 142a-142n may provide hard surfaces to receive the jack screws 144a-144n. The jack screws 144a-144n may be tightened after at least the active areas 130 of the fuel cells 118a-118n have been compressed to the target active area pressure. The jack screws 144a-144n generally maintain the compression of the active areas 130 after the active area pins 86a-86n are removed. The compression plate 146 may be configured as an internal component that spreads the pressure applied by the pin array and by the jack screws 144a-144n across a surface of the fuel cells 118a-118n.

Referring to FIG. 7, a schematic cross-sectional perspective diagram of the region 150 of the dry end unit 104 is shown in accordance with one or more exemplary embodiments of the fuel cell system 100. The dry end unit 104 further comprises an insulator plate 152, multiple pin holes 154 (one shown), an insulating film 156, a terminal plate 158 and a face seal 160. A gap 162 may be formed between the insulator plate 152 and the insulating film 156.

The insulator plate 152 may be configured as an electrically insulating end component of the dry intermediate plate 112a that faces the fuel cells 118a-118n. The pin holes 154 may be sized and positioned to allow the active area pins 86a-86n (pin 86c is illustrated) to pass through and contact the insulating film 156.

The insulating film 156 may be disposed between the insulator plate 152 and the terminal plate 158. The insulating film 156 is generally operational to electrically isolate the terminal plate 158 from the dry end unit 104, except for the first electrical terminal 122.

The face seal 160 may implement a resilient seal. The face seal 160 is generally operational to maintain an environmental seal and an arc tracking barrier between the insulator plate 152 and the insulating film 156. The face seal 160 may create the gap 162 between the insulator plate 152 and the insulating film 156 before the pin array bears on the dry intermediate plate 112a. The gap 162 may be reduced as the active area pins 86a-86n press on the insulating film 156. The gap 162 generally aids the pressure sensors 82a-82n in measuring a force that the active area pins 86a-86n are applying to the active area 130 of the fuel cells 118a-118n.

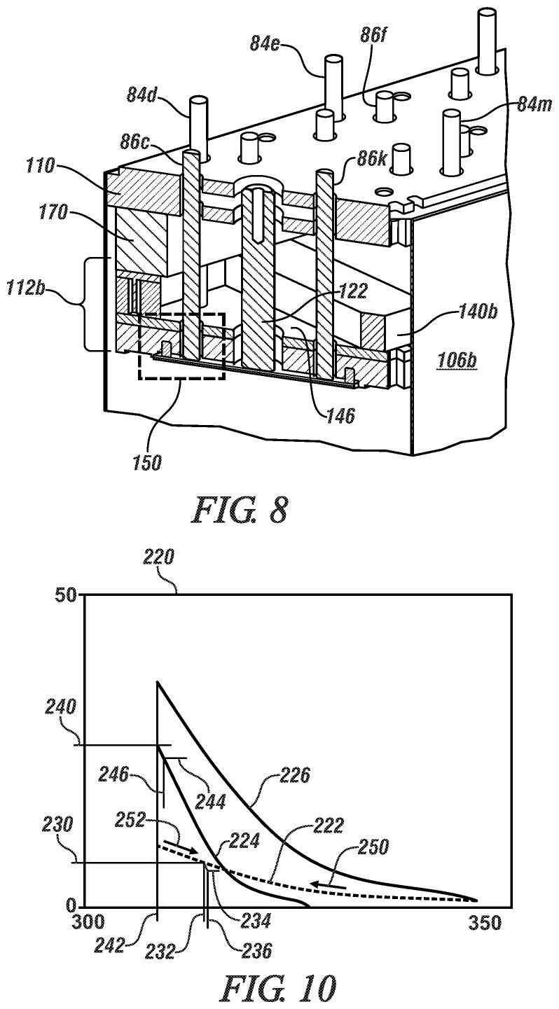

Referring to FIG. 8, a schematic cross-sectional perspective diagram of another example implementation of a portion of the dry end unit 104 is shown in accordance with one or more exemplary embodiments of the fuel cell system 100. The dry end unit 104 generally comprises the dry base plate 110, a dry intermediate plate 112b and the first electrical terminal 122. The active area pins 86a-86n and the perimeter area pins 84a-84n are illustrated in positions to bias the dry intermediate plate 112b toward the wet intermediate plate 114 (e.g., downward as shown in the figure). A region 150 shows an area of the dry end unit 104 shown in more detail in FIG. 7.

The dry intermediate plate 112b may be a variation of the dry intermediate plate 112. The dry intermediate plate 112b generally comprises the multiple cross supports 140a-140n (one shown), the compression plate 146 and a shim 170.

The shim 170 may be implemented as a non-compressible beam used to hold the dry intermediate plate 112b at a fixed distance from the dry base plate 110. A thickness of the shim 170 may be selected, and the selected shim 170 may be installed in the fuel cell system 100 while the pin array has the fuel cells 118a-118n compressed to the target pressures. The selected shim 170 may maintain the target pressures on the fuel cells 118a-118n after the pin array has been withdrawn from the fuel cell system 100.

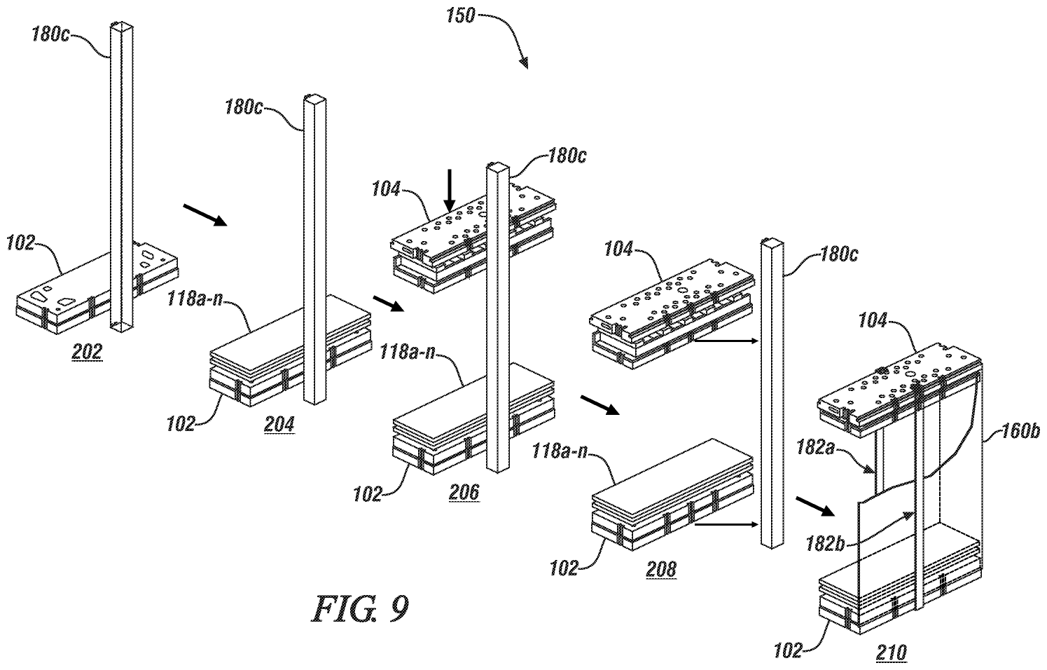

Referring to FIG. 9, a schematic diagram of an example method 200 of fabricating the fuel cell system 100 is shown in accordance with one or more exemplary embodiments. The method (or process) 200 may be implemented using the compression machine 80. The method 200 generally comprises a step 202, a step 204, a step 206, a step 208 and a step 210. The sequence of steps is shown as a representative example. Other step orders may be implemented to meet the criteria of a particular application.

In the step 202, the wet end unit 102 may be placed in the compression machine 80. The wet end unit 102 may be aligned within the compression machine 80 by multiple build datums 180a-180e (only build datum 180c is shown for clarity). The fuel cells 118a-118n may be placed onto the wet end unit 102 in the step 204. The fuel cells 118a-118n may be aligned to the wet end unit 102 by the build datums 180a-180e. In the step 206, the dry end unit 104 may be placed onto the fuel cells 118a-118n. The dry end unit 104 may be aligned to the wet end unit 102 by the build datums 180a-180e.

The dry intermediate plate 112, 112a, 112b may be pressed by the pin array in the step 206 to compress the fuel cells 118a-118n. The build datums 180a-180e may moved away from the wet end unit 102, the fuel cells 118a-118n and the dry end unit 104 in the step 208 once the target pressures have been reached and the dry intermediate plate 112, 112a, 112b is set at a fixed displacement from the dry base plate 110. In the step 210, at least two straps 182a-182b and the sidewalls 106a-106d may be attached to the wet end unit 102 and the dry end unit 104. The pin array may subsequently be removed from the fuel cell system 100.

Referring to FIG. 10, a graph 220 of example loading profiles and unloading profiles of the fuel cells 118a-118n are shown in accordance with one or more example embodiments of the fuel cell system 100. The loading profiles and unloading profiles may be created in the fuel cell system 100 by the compression machine 80.

The x-axis may illustrate a stack length in millimeters (mm). The y-axis may illustrate a build pressure in kilo-Newtons (kN). The pin array loading on the fuel cells 118a-118n is shown by arrow 250. The graph 220 generally comprises an active area loading curve 222, a perimeter area loading curve 224 and a total loading curve 226.

The load on the active areas 130 of the fuel cells 118a-118n created by the active area pins 86a-86n may be increased until the load (or pressure or force) achieves the target active area pressure 230. The load on the perimeter areas 132 of the fuel cells 118a-118n created by the perimeter area pins 84a-84n may be increased until the load (or pressure or force) achieves the target perimeter area pressure 240. The active areas 130 of the fuel cells 118a-118n may reach a target active length 232 when the target pressures 230 and 240 are achieved. The perimeter areas 132 of the fuel cells 118a-118n may reach a target perimeter length 242 when the target pressures 230 and 240 are achieved. In some situations, the target active length 232 may match the target perimeter length 242. In other situations, the target active length 232 may be different than the target perimeter length 242.

When the pin array is removed from the fuel cell system 100, the fuel cells 118a-118n may relax in response to the unloading. The unloading is show by arrow 252. For example, the pressure in the active areas 130 may relax to a retained active area pressure 234 at a retained active length 236. The pressure in the perimeter areas 132 may relax to a retained perimeter area pressure 244 at a retained perimeter length 246. In various situations, the retained active area pressure 234 may be similar to, although slightly less than the target active area pressure 230. The retained perimeter area pressure 244 may be similar to, although slightly less than the target perimeter area pressure 240. In situations where the jack screws 144a-144n or the shims 170 prevent the relaxation, the retained active area pressure 234 may be the same as the target active area pressure 230, and the retained perimeter area pressure 244 may be the same as the target perimeter area pressure 240.

When pressing with the actual wet end unit 102 and the actual dry end unit 104, the loading curves 222, 224 and 226 during build press retractions may confirm that the retained pressures 234 and 244 are within limits of the target pressures 230 and 240. The build press retractions may be used to adjust the target pressures 230 and 240 to further improve control.

Embodiments of the fuel cell system 100 and the method 200 generally provided a pin array that bears on a terminal plate 158, which covers the active areas 130 of the fuel cells 118a-118n. In various embodiments, the pin array may also bear on the insulator plate 152, which covers the perimeter areas 132 of the fuel cells 118a-118n. The method 200 may improve a quality of the fuel cell system 100, a cycle time to fabricate the fuel cell system 100, a process yield and a cost benefit. The stack build method 200 compresses the stack once with the pin array and measures the load applied in the active areas 130 for quality control purposes.

While the best modes for carrying out the disclosure have been described in detail, those familiar with the art to which this disclosure relates will recognize various alternative designs and embodiments for practicing the disclosure within the scope of the appended claims.

1. A fuel cell system comprising:
a dry end unit having a dry base plate and a dry intermediate plate, wherein the dry intermediate plate is initially moveable relative to the dry base plate during a fabrication of the fuel cell system;
a wet end unit having a wet base plate and a wet intermediate plate, wherein the wet intermediate plate adjoins the wet base plate;
a plurality of fuel cells disposed between the dry intermediate plate and the wet intermediate plate, wherein each of the plurality of fuel cells includes a perimeter area that surrounds an active area; and
wherein the dry intermediate plate is fixed in position relative to the dry base plate during the fabrication to maintain the active areas of the plurality of fuel cells at a target active area pressure.

2. The fuel cell system according to claim 1, wherein the dry intermediate plate comprises:
a terminal plate configured to engage the plurality of fuel cells;
an insulator plate that has a plurality of holes through which a pin array applies a load to the terminal plate to compress the plurality of fuel cells; and
a gap between the terminal and the insulator plate to aid in measuring the load through at least one pin of the pin array.

3. The fuel cell system according to claim 2, further comprising a first electrical terminal electrically connected to the terminal plate, extending through the dry base plate, and adjustable in a direction perpendicular to the dry intermediate plate.

4. The fuel cell system according to claim 2, further comprising:
a plurality of straps configured to secure the dry end unit mechanically to the wet end unit.

5. The fuel cell system according to claim 4, wherein the pin array is removed from the fuel cell system after the dry end unit is secured to the wet end unit.

6. The fuel cell system according to claim 2, wherein the pin array comprises a plurality of active area pins and a plurality of perimeter area pins, the active area pins compress the active areas of the plurality of fuel cells to the target active area pressure, and the plurality of perimeter pins compress the perimeter areas of the plurality of fuel cells to a target perimeter area pressure.

7. The fuel cell system according to claim 6, wherein the target active area pressure is different than the target perimeter area pressure.

8. The fuel cell system according to claim 1, wherein the dry intermediate plate is fixed in position relative to the dry base plate by a plurality of jack screws disposed between the dry intermediate plate and the dry base plate or a plurality of shims disposed between the dry intermediate plate and the dry base plate.

9. The fuel cell system according to claim 1, wherein the fuel cell system forms part of a vehicle.

10. A method for fabricating a fuel cell system, comprising:
placing a wet end unit into a compression machine, wherein the wet end unit includes a wet base plate and a wet intermediate plate, and the compression machine includes a pin array;
placing a plurality of fuel cells into the compression machine adjoining the wet end unit, wherein each of the plurality of fuel cells includes a perimeter area that surrounds an active area;
placing a dry end unit into the compression machine adjoining the plurality of fuel cells, wherein the dry end unit includes a dry base plate and a dry intermediate plate, and the dry intermediate plate is moveable relative to the dry base plate;
applying a load to the dry intermediate plate with the pin array of the compression machine to compress the plurality of fuel cells between the dry intermediate plate and the wet intermediate plate, wherein the load is increased until the active areas of the plurality of fuel cells are compressed to a target active area pressure; and
fixing the dry intermediate plate in position relative to the dry base plate to maintain the active areas of the plurality of fuel cells at the target active area pressure.

11. The method according to claim 10, further comprising:
securing the dry end unit mechanically to the wet end unit.

12. The method according to claim 11, further comprising:
removing the pin array from the fuel cell system after the dry end unit is secured to the wet end unit.

13. The method according to claim 10, wherein the pin array comprises a plurality of active area pins and a plurality of perimeter area pins, the active area pins compress the active areas of the plurality of fuel cells to the target active area pressure, and the plurality of perimeter pins compress the perimeter areas of the plurality of fuel cells to a target perimeter area pressure.

14. The method according to claim 13, wherein the target active area pressure is different than the target perimeter area pressure.

15. The method according to claim 13, further comprising:
measuring an active area pressure asserted by the plurality of active area pins; and
measuring a perimeter area pressure asserted by the plurality of perimeter area pins.

16. The method according to claim 15, further comprising:
stopping movement of the active area pins in response to the active area pressure as measured reaching the target active area pressure; and
stopping movement of the perimeter area pins in response to the perimeter area pressure as measured reaching the target perimeter area pressure.

17. A vehicle comprising:
an electric motor configured to provide propulsion to the vehicle;
a plurality of fuel tanks configured to store fuel; and
a fuel cell system configured to convert the fuel into electricity that powers the electric motor, wherein the fuel cell system comprises:
a dry end unit having a dry base plate and a dry intermediate plate, wherein the dry intermediate plate is initially moveable relative to the dry base plate during a fabrication of the fuel cell system;
a wet end unit having a wet base plate and a wet intermediate plate, wherein the wet intermediate plate adjoins the wet base plate;
a plurality of fuel cells disposed between the dry intermediate plate and the wet intermediate plate, wherein each of the plurality of fuel cells includes a perimeter area that surrounds an active area; and
wherein the dry intermediate plate is fixed in position relative to the dry base plate during the fabrication to maintain the active areas of the plurality of fuel cells at a target active area pressure.

18. The vehicle according to claim 17, wherein a pin array used to compress the dry end plate toward the wet end plate comprises a plurality of active area pins and a plurality of perimeter area pins, the active area pins compress the active areas of the plurality of fuel cells to the target active area pressure, and the plurality of perimeter pins compress the perimeter areas of the plurality of fuel cells to a target perimeter area pressure.

19. The vehicle according to claim 18, wherein the target active area pressure is different than the target perimeter area pressure.

20. The vehicle according to claim 17, wherein the plurality of fuels comprises hydrogen and oxygen.
